(19) United States
(12) Patent Application Publication
(10) Pub. No.: US 2021/0299637 A1
(43) Pub. Date: Sep. 30, 2021

(54) OXYGEN STORAGE CAPACITY MATERIAL

(71) Applicant: JOHNSON MATTHEY PUBLIC LIMITED COMPANY, London (GB)

(72) Inventors: Masayuki KOBAYASHI, Kitsuregawa (JP); Shuhei NAGAOKA, Kitsuregawa (JP)

(21) Appl. No.: 17/249,952

(22) Filed: Mar. 19, 2021

Related U.S. Application Data
(60) Provisional application No. 63/001,708, filed on Mar. 30, 2020.

(51) Int. Cl. B01J 21/06; B01J 35/00; F01N 3/10; B01J 23/89; B01J 23/00; B01J 23/83

(52) U.S. Cl. CPC B01J 21/066; B01J 35/002; F01N 3/101; F01N 3/0835; B01J 23/002; B01J 23/83; B01J 23/8906

(57) ABSTRACT

An improved oxygen storage capacity material comprising a mixed oxide is disclosed. Catalysts, systems and methods using the improved oxygen storage capacity material for abating emissions in an exhaust stream are provided.

### TECHNICAL FIELD

The present invention relates to an improved oxygen storage capacity material and its use in catalyst compositions, systems, and methods for emissions treatment.

### BACKGROUND OF THE INVENTION

Three-way catalyst (TWC) can simultaneously catalyse both oxidation and reduction reactions, such as the oxidation of hydrocarbons and carbon monoxide and the reduction of nitrogen oxides in a gaseous stream. TWC catalyst finds utility in many fields, including the treatment of the exhaust gases from internal combustion engines, such as automobile, truck and other gasoline-fueled engines.

TWC catalyst generally includes an oxygen storage capacity (OSC) material. Most OSC materials are based on mixed oxides or composite oxides of CeO₂ and ZrO₂ (WO2008113445A1; U.S. Pat. No, 7,943,104). In these OSC materials, CeO₂ is employed to buffer the catalyst from local variations in the air/fuel ratio during typical catalyst operation. It achieves this by releasing active oxygen from its structure in a rapid and reproducible manner under oxygen-depleted transients and regenerating the oxygen by adsorption from the gaseous phase under oxygen-rich conditions. The high availability of oxygen is critical for promoting redox reactions for the three-way catalyst,

There have been extensive studies on the synthesis, modification and optimization of ceria-zirconia mixed oxide based OSC materials. For example, the use of ceria-zirconia doped with lower valent ions for emission control applications has been investigated, see Catalysis Today 327 (2019) 90-115.

A need exists in the art for catalytic materials that are more effective in emissions treatment.

### SUMMARY OF THE INVENTION

One aspect of the present disclosure is directed to an oxygen storage capacity material comprising a mixed oxide, the mixed oxide comprising ceria in an amount of about 10 to about 80 weight percent (wt %); zirconia in an amount of about 10 to about 80 wt %; and a transition metal oxide in an amount of about 0.05 to about 1.0 wt %; wherein the transition metal is selected from the group consisting of titanium, vanadium, chromium, manganese, iron, cobalt, copper, zinc, zirconium, niobium, and mixtures thereof.

Another aspect of the present disclosure is directed to a catalyst composition comprising a platinum group metal component and the OSC material comprising the mixed oxide.

Another aspect of the present disclosure is directed to a catalyst article for treating exhaust gas comprising: a substrate; and a first catalytic region on the substrate; wherein the first catalytic region comprises a first PGM component and a first OSC material. In one particularly embodiment, the first OSC material is a mixed oxide comprising ceria in an amount of about 10 to about 80 wt %; zirconia in an amount of about 10 to about 80 wt %; and a transition metal oxide in an amount of about 0.05 to about 1.5 wt %; wherein the transition metal is selected from the group consisting of titanium, vanadium, chromium, manganese, iron, cobalt, copper, zinc, zirconium, niobium, and mixtures thereof.

Another aspect of the present disclosure is directed to a method for treating a vehicular exhaust gas containing NOₓ, CO, and hydrocarbons (“HC”) using the catalyst article described herein.

Another aspect of the present disclosure is directed to a system for treating exhaust gas comprising the catalyst article described herein.

### BRIEF DESCRIPTION OF THE DRAWING

FIG. 1 shows the XRD patterns of OSC materials A, B, F, and G after redox aging.

### DETAILED DESCRIPTION OF THE INVENTION

One aspect of the present disclosure is directed to an oxygen storage capacity material comprising a mixed oxide, the mixed oxide comprising ceria in an amount of about 10 to about 80 wt %; zirconia in an amount of about 10 to about 80 wt %; and a transition metal oxide in an amount of about 0.05 to about 1.0 wt %, wherein the transition metal is selected from the group consisting of titanium, vanadium, chromium, manganese, iron, cobalt, copper, zinc, zirconium, niobium, and mixtures thereof.

“Oxygen storage capacity” refers to the ability of materials used as oxygen storage capacity material in catalysts to store oxygen at lean conditions and to release it at rich conditions.

Optimal use of the TWC is around Lambda=1 where the air/fuel ratio is equal to 14.56. Above these values, the exhaust gas is said lean, and CO and HC are catalytically oxidized to carbon dioxide and water. Below this value, the exhaust gas is said rich and mainly NOₓ are reduced to nitrogen (N₂) using e.g., CO as reducing agent.

The term “mixed oxide” as used herein generally refers to a mixture of oxides in a single phase, as is conventionally known in the art.

Preferably, the Ce cation and Zr cation in the mixed oxide are atomically well mixed. For example, XRD can be used to detect the presence of pyrochlore in the mixed oxide. Preferably, the mixed oxide comprises pyrochlore as determined by XRD.

Preferably, the transition metal in the mixed oxide is selected from the group consisting of manganese, iron, copper, and mixtures thereof. More preferably, the transition metal is iron.

The amount of the transition metal oxide present in the mixed oxide is preferably in an amount of about 0.1 to about 1.0 wt %, more preferably about 0.1 to about 0.8 wt %, most preferably about 0.2 to about 0.6 wt %.

The mixed oxide may comprise a dopant selected from the group consisting of praseodymium oxide, lanthanum oxide, yttrium oxide, and mixtures thereof. The amount of the dopant typically is about 1.0 to about 10 wt %.

The mixed oxide can be formed by techniques such as co-gelling, co-precipitation, plasma spraying, flame spray pyrolysis and the like. For example, a coprecipitation method can be used, in which an aqueous solution that include a salt (e.g., nitrate) of cerium, a salt (e.g., nitrate) of zirconium, and at least one salt selected from the group consisting of salts (e.g., nitrates) of manganese, iron, copper, and mixtures thereof. In addition, salts of praseodymium, salts (e.g., nitrate) of lanthanum, and salts (e.g., nitrate) of yttrium may be used in forming the mixed oxide. The mixed oxide formed from the co-precipitation can be isolated by e.g., filtration, washed, dried, calcined, and then pulverized using a pulverizer such as a ball mill to obtain the mixed oxide powder.

Another aspect of the present disclosure is directed to a catalyst composition comprising a platinum group metal (PGM) component and the OSC material comprising the mixed oxide. The acronym “PGM” refers to “platinum group metal”. The term “platinum group metal” generally refers to a metal selected from the group consisting of Ru, Rh, Pd, Os, Jr and Pt, preferably a metal selected from the group consisting of Ru,

Rh, Pd, Jr and Pt. In some embodiments, the term “PGM” preferably refers to a metal selected from the group consisting of Rh, Pt and Pd. In some other embodiments, the PGM component is Pd or Rh. In further embodiments, the PGM component is Pd.

The amount of the PGM component in the catalyst composition can be from 0.01 to 20 wt %, preferably from 0.05 to 10 wt %, more preferably from 0.2 to 5.0 wt %.

The catalyst composition can further comprise an inorganic oxide support. The inorganic oxide support can be an oxide of Groups 2, 3, 4, 5, 13 and 14 elements. The inorganic oxide support is preferably a refractory oxide that exhibits chemical and physical stability at high temperatures, such as the temperatures associated with gasoline engine exhaust. The inorganic oxide support can be selected from the group consisting of alumina, silica, titania, and mixed oxides or composite oxides thereof. More preferably, the inorganic oxide support is an alumina. The inorganic oxide support can be used as a carrier material for the PGM component.

The inorganic oxide support preferably has a fresh surface area of greater than 80 m²/g and a pore volume in the range of from about 0.1 to about 4 mL/g. A high surface area inorganic oxide support having a surface area greater than 100 m²/g are particularly preferred, e.g., high surface area alumina.

The inorganic oxide support can be doped with a dopant. The dopant can be selected from the group consisting of La, Sr, Si, Ba, Y, Pr, Nd, Ce, and mixtures thereof. Preferably, the dopant is La, Ba, or Ce. Most preferably, the dopant is La. The dopant content in the inorganic oxide support can be from about 5 to about 30 wt %, preferably from about 8 to about 25 wt %, more preferably from about 10 to about 20 wt %.

The OSC material and the inorganic oxide support can have a weight ratio of from about 10:1 to about 1:10, preferably, from about 8:1 to about 1:8 or from about 5:1 to about 1:5; more preferably, from about 4:1 to about 1:4 or from about 3:1 to about 1:3;

and most preferably, from about 2:1 to about 1:2.

The catalyst composition may comprise an alkali or alkaline earth metal. In some embodiments, the alkali or alkaline earth metal may be deposited on the OSC material. Alternatively, or in addition, the alkali or alkaline earth metal may be deposited on the inorganic oxide support. That is, in some embodiments, the alkali or alkaline earth metal may be deposited on, i.e., present on, both the OSC material and the inorganic oxide support.

Preferably the alkali or alkaline earth metal is supported/deposited on the inorganic oxide support. In addition to, or alternatively to, being in contact with the inorganic oxide support, the alkali or alkaline earth metal may be in contact with the OSC material and the PGM component.

The alkali or alkaline earth metal is preferably barium or strontium. Preferably the barium or strontium, where present, is present in an amount of from about 0.1 to about 15 wt %, more preferably from about 3 to about 10 wt %, based on the total weight of the catalyst composition.

The alkali or alkaline earth metal is more preferably barium. Preferably barium is present in an amount of from about 0.1 to about 15 wt %, more preferably from about 3 to about 10 wt %, based on the total weight of the catalyst composition.

Preferably the barium is present as a BaCO₃ composite material. Such a material can be pre-formed by any method known in the art, for example incipient wetness impregnation or spray-drying.

The catalyst composition comprising the OSC material of the present invention gives significantly improved performance than the catalyst composition containing a similar ceria-zirconia mixed oxide OSC material, as shown in Examples 5 and 6.

Another aspect of the present disclosure is directed to a catalyst article for treating exhaust gas comprising: a substrate; and a first catalytic region on the substrate; wherein the first catalytic region comprises a first PGM component, and a first OSC material.

The first PGM component can be Pd, Rh, or Pt. In some embodiments, the first PGM component is Pd or Rh. In other embodiments, the first PGM component is Pd. In yet another further embodiment, the first catalytic region is substantially free of PGMs other than palladium.

The first catalytic region can comprise up to 350 g/ft³ of the first PGM component. Preferably, the first catalytic region can comprise from about 10 to about 300 g/ft³, more preferably, from about 25 to about 150 g/ft³ of the first PGM component.

The first catalytic region may comprise a first inorganic oxide support. The first inorganic oxide support can be an oxide of Groups 2, 3, 4, 5, 13 and 14 elements. The first inorganic oxide support is preferably a refractory metal oxide that exhibits chemical and physical stability at high temperatures, such as the temperatures associated with gasoline engine exhaust. The first inorganic oxide support can be selected from the group consisting of alumina, silica, titania, and mixed oxides or composite oxides thereof.

More preferably, the first inorganic oxide support is an alumina. The first inorganic oxide support can be a carrier material for the first PGM component.

The first inorganic oxide support preferably has a fresh surface area of greater than 80 m²/g and a pore volume in the range from about 0.1 mL/g to about 4 mL/g. High surface area inorganic oxides having a surface area greater than about 100 m²/g are particularly preferred, e.g., high surface area alumina.

The first inorganic oxide support can be doped with a dopant. The dopant can be selected from the group consisting of La, Sr, Si, Ba, Y, Pr, Nd, and Ce. Preferably, the dopant can be La, Ba, or Ce. More preferably, the dopant is La. The dopant content in the first inorganic oxide support can be from about 10 to about 30 wt %, preferably from about 10 to about 25 wt.%, more preferably from about 10 to about 20 wt %.

The total washcoat loading of the first catalytic region can be from about 0.1 to about 5 g/in³. Preferably, the total washcoat loading of the first catalytic region is from about 0.5 to about 3.5 g/in³, most preferably, the total washcoat loading of the first catalytic region is from about 1 to about 2.5 g/in³.

The first OSC material is preferably selected from the group consisting of cerium oxide, zirconium oxide, a ceria-zirconia mixed oxide, and an alumina-ceria-zirconia mixed oxide. More preferably, the first OSC material comprises a ceria-zirconia mixed oxide. The ceria-zirconia mixed oxide can further comprise some dopants, such as, La, Nd, Y, Pr, etc.

In one particularly embodiment, the first OSC material is a mixed oxide comprising ceria in an amount of about 10 to about 80 weight wt %; zirconia in an amount of about 10 to about 80 wt %; and a transition metal oxide in an amount of about 0.05 to about 1.5 wt %; wherein the transition metal is selected from the group consisting of titanium, vanadium, chromium, manganese, iron, cobalt, copper, zinc, zirconium, niobium, and mixtures thereof. Preferably, the transition metal in the mixed oxide in the first OSC material is selected from the group consisting of manganese, iron, copper, and mixtures thereof. More preferably, the transition metal is iron. The amount of the transition metal oxide present in the mixed oxide in the first OSC material is preferably in an amount of about 0.1 to about 1.0 wt %, more preferably about 0.1 to about 0.8 wt % relative to the mixed oxide, most preferably about 0.2 to about 0.6 wt %.

The mixed oxide in the first OSC material may comprise a dopant selected from the group consisting of praseodymium oxide, lanthanum oxide, and yttrium oxide, and mixtures thereof. The amount of the dopant typically is about 1.0 to about 10 wt % relative to the mixed oxide.

The first OSC material can be from about 10 to about 90 wt %, preferably, from about 25 to about 75 wt %, more preferably from about 35 to about 65 wt %, based on the total washcoat loading of the first catalytic region.

The first OSC material loading in the first catalytic region can be less than about 1.5 g/in³. In some embodiments, the first OSC material loading in the first catalytic region is no greater than, for example, 1.2 g/in³, 1.0 g/in³, 0.9 g/in³, 0.8 g/in³, 0.7 g/in³, or 0.6 g/in³.

The first OSC material and the first inorganic oxide support can have a weight ratio of no greater than 10:1, preferably, no greater than 8:1 or 5:1, more preferably, no greater than 4:1 or 3:1, most preferably, no greater than 2:1.

Alternatively, the first OSC material and the first inorganic oxide support can have a weight ratio of 10:1 to 1:10, preferably, 8:1 to 1:8 or 5:1 to 1:5; more preferably, 4:1 to 1:4 or 3:1 to 1:3; and most preferably, 2:1 to 1:2.

The first catalytic region may further comprise a first alkali or alkaline earth metal component. In some embodiments, the first alkali or alkaline earth metal may be deposited on the first OSC material. Alternatively, or in addition, the first alkali or alkaline earth metal may be deposited on the first inorganic oxide support. That is, in some embodiments, the first alkali or alkaline earth metal may be deposited on, i.e. present on, both the first OSC material and the first inorganic oxide support.

Preferably the first alkali or alkaline earth metal is supported/deposited on the first inorganic oxide support. In addition to, or alternatively to, being in contact with the first inorganic oxide support, the first alkali or alkaline earth metal may be in contact with the first OSC material and the first PGM component.

The first alkali or alkaline earth metal is preferably barium or strontium. Preferably the barium or strontium, where present, is present in an amount of about 0.1 to about 15 wt %, and more preferably about 3 to about 10 wt %, based on the total washcoat loading of the first catalytic region.

The first alkali or alkaline earth metal is more preferably barium. Preferably barium is present in an amount of from about 0.1 to about 15 wt %, more preferably from about 3 to about 10 wt %, based on the total washcoat loading of the first catalytic region.

Preferably the barium is present as a BaCO₃ composite material. Such a material can be performed by any method known in the art, for example incipient wetness impregnation or spray-drying.

The catalyst article can further comprise a second catalytic region. The second catalytic region can comprise a second PGM component, a second oxygen storage capacity material, a second alkali or alkaline earth metal component, and/or a second inorganic oxide.

The second PGM component can be selected from the group consisting of palladium, platinum, rhodium, and a mixture thereof. In some embodiments, the second PGM component can be Pd, when the first PGM component is Rh. In other embodiments, the second PGM component can be Rh, when the first PGM component is Pd.

The second catalytic region can comprise up to about 350 g/ft³ of the second PGM component. Preferably, the second catalytic region can comprise from about 10 to about 300 g/ft³, more preferably from about 25 to about 150 g/ft³ of the second PGM component.

The total washcoat loading of the second catalytic region can be from about 0.1 to about 5 g/in³. Preferably, the total washcoat loading of the second catalytic region is from about 0.5 to about 3.5 g/in³. More preferably, the total washcoat loading of the second catalytic region is from about 1 to about 2.5 g/in³.

The second inorganic oxide support is preferably an oxide of Groups 2, 3, 4, 5, 13 and 14 elements. The second inorganic oxide support is preferably selected from the group consisting of alumina, magnesia, lanthana, silica, neodymium, praseodymium, yttrium oxides, titania, niobia, tantalum oxides, molybdenum oxides, tungsten oxides, and mixed oxides or composite oxides thereof. More preferably, the second inorganic oxide support is selected from the group consisting of alumina, magnesia, silica, lanthanum, neodymium, praseodymium, yttrium oxides, and mixed oxides or composite oxides thereof. Particularly preferably, the second inorganic oxide support is alumina, a lanthanum/alumina composite oxide, or a magnesia/alumina composite oxide. One especially preferred second inorganic oxide support is a lanthanum/alumina composite oxide. The second inorganic oxide support may be a support material for the second PGM component, and/or for the second alkali or alkaline earth metal.

The second inorganic oxide support preferably have a fresh surface area of greater than 80 m²/g, pore volumes in the range of from about 0.1 to about 4 mL/g. High surface area inorganic oxide supports having a surface area greater than 100 m²/g are particularly preferred, e.g., high surface area alumina. Other preferred second inorganic oxide supports include lanthanum/alumina composite oxides, optionally further comprising a cerium-containing component, e.g., ceria. In such cases the ceria may be present on the surface of the lanthanum/alumina composite oxide, e.g., as a coating.

Alternatively, the second inorganic oxide support can also have the same features as the first inorganic oxide support.

The second OSC material is preferably selected from the group consisting of cerium oxide, zirconium oxide, a ceria-zirconia mixed oxide, and an alumina-ceria-zirconia mixed oxide. More preferably, the second OSC material comprises the ceria-zirconia mixed oxide. The ceria-zirconia mixed oxide can further comprise some dopants, such as, La, Nd, Y, Pr, etc. The ceria-zirconia mixed oxide can have a molar ratio of zirconia to ceria at least 50:50, preferably, higher than 60:40, more preferably, higher than 75:25. In addition, the second OSC material may function as a carrier for the second PGM component. In some embodiments, the second PGM component are deposited on the second OSC material and the second inorganic oxide support.

In one particular embodiment, the second OSC material is a mixed oxide comprising ceria in an amount of about 10 to about 80 wt %; zirconia in an amount of about 10 to about 80 wt %; and a transition metal oxide in an amount of about 0.05 to about 1.5 wt %, wherein the transition metal is selected from the group consisting of titanium, vanadium, chromium, manganese, iron, cobalt, copper, zinc, zirconium, niobium, and mixtures thereof. Preferably, the transition metal oxide in the mixed oxide is selected from the group consisting of manganese, iron, copper, and mixtures thereof. More preferably, the transition metal is iron. The amount of the transition metal oxide present in the metal oxide of the second OSC material is preferably in an amount of about 0.1 to about 1.0 wt %, more preferably about 0.1 to about 0.8 wt % relative to the mixed oxide, most preferably about 0.2 to about 0.6 wt %. The mixed oxide of the second OSC material may comprise a dopant selected from the group consisting of praseodymium oxide, lanthanum oxide, and yttrium oxide, and mixtures thereof. The amount of the dopant typically is about 1.0 to about 10 wt % relative to the mixed oxide.

The second OSC material can be from about 10 to about 90 wt %, preferably from about 25 to about 75 wt %, more preferably from about 35 to about 65 wt %, based on the total washcoat loading of the second catalytic region.

The second OSC material loading in the second catalytic region can be less than about 1.5 g/in³. In some embodiments, the second OSC material loading in the second catalytic region is no greater than, for example, 1.2 g/in³, 1.0 g/in³, 0.9 g/in³, 0.8 g/in³, 0.7 g/in³, or 0.6 g/in³.

The second OSC material and the second inorganic oxide support can have a weight ratio of no greater than 10:1, preferably, no greater than 8:1 or 5:1, more preferably, no greater than 4:1 or 3:1, most preferably, no greater than 2:1.

Alternatively, the second OSC material and the second inorganic oxide support can have a weight ratio of 10:1 to 1:10, preferably, 8:1 to 1:8 or 5:1 to 1:5; more preferably, 4:1 to 1:4 or 3:1 to 1:3; and most preferably, 2:1 to 1:2.

In some embodiments, the second alkali or alkaline earth metal may be deposited on the second OSC material. Alternatively, or in addition, the second alkali or alkaline earth metal may be deposited on the second inorganic oxide. That is, in some embodiments, the second alkali or alkaline earth metal may be deposited on, i.e. present on, both the second OSC material and the second inorganic oxide support.

Preferably the second alkali or alkaline earth metal is supported/deposited on the second inorganic oxide support. In addition to, or alternatively to, being in contact with the second inorganic oxide, the second alkali or alkaline earth metal may be in contact with the second OSC material and the second PGM component.

The second alkali or alkaline earth metal is preferably barium or strontium. Preferably the barium or strontium, where present, is present in an amount of about 0.1 to about 15 wt %, and more preferably about 3 to about 10 wt %, based on the total washcoat loading of the second catalytic region.

The second alkali or alkaline earth metal is more preferably barium. Preferably barium is present in an amount of from about 0.1 to about 15 wt %, more preferably from about 3 to about 10 wt %, based on the total washcoat loading of the second catalytic region.

Preferably the barium is present as a BaCO₃ composite material. Such a material can be performed by any method known in the art, for example incipient wetness impregnation or spray-drying.

In some embodiments, the first PGM component and the second PGM component has a weight ratio of from about 60:1 to about 1:60. Preferably, the first PGM component and the second PGM component has a weight ratio of from 30:1 to 1:30. More preferably, the first PGM component and the second PGM component has a weight ratio of from 20:1 to 1:20. Most preferably, the first PGM component and the second PGM component has a weight ratio of from 15:1 to 1:15.

Preferably the substrate is a flow-through monolith, or wall flow gasoline particulate filter. More preferably, the substrate is a flow-through monolith.

The flow-through monolith substrate has a first face and a second face defining a longitudinal direction there between. The flow-through monolith substrate has a plurality of channels extending between the first face and the second face. The plurality of channels extend in the longitudinal direction and provide a plurality of inner surfaces (e.g., the surfaces of the walls defining each channel). Each of the plurality of channels has an opening at the first face and an opening at the second face. For the avoidance of doubt, the flow-through monolith substrate is not a wall flow filter.

The first face is typically at an inlet end of the substrate and the second face is at an outlet end of the substrate.

The channels may be of a constant width and each plurality of channels may have a uniform channel width.

Preferably within a plane orthogonal to the longitudinal direction, the monolith substrate has from 100 to 900 channels per square inch, preferably from 300 to 750. For example, on the first face, the density of open first channels and closed second channels is from 300 to 750 channels per square inch. The channels can have cross sections that are rectangular, square, circular, oval, triangular, hexagonal, or other polygonal shapes.

The monolith substrate acts as a support for holding catalytic material. Suitable materials for forming the monolith substrate include ceramic-like materials such as cordierite, silicon carbide, silicon nitride, zirconia, mullite, spodumene, alumina-silica magnesia or zirconium silicate, or of porous, refractory metal. Such materials and their use in the manufacture of porous monolith substrates is well known in the art.

It should be noted that the flow-through monolith substrate described herein is a single component (i.e. a single brick). Nonetheless, when forming an emission treatment system, the monolith used may be formed by adhering together a plurality of channels or by adhering together a plurality of smaller monoliths as described herein. Such techniques are well known in the art, as well as suitable casings and configurations of the emission treatment system.

In embodiments wherein the catalyst article of the present comprises a ceramic substrate, the ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates and metallo aluminosilicates (such as cordierite and spodumene), or a mixture or mixed oxide of any two or more thereof. Cordierite, a magnesium aluminosilicate, and silicon carbide are particularly preferred.

In embodiments wherein the catalyst article of the present invention comprises a metallic substrate, the metallic substrate may be made of any suitable metal, and in particular heat-resistant metals and metal alloys such as titanium and stainless steel as well as ferritic alloys containing iron, nickel, chromium, and/or aluminum in addition to other trace metals.

In some embodiments, the first catalytic region is supported/deposited directly on the substrate. In further embodiments, the second catalytic region is supported/deposited on the first catalytic region.

In other embodiments, the second catalytic region is supported/deposited directly on the substrate. In further embodiments, the first catalytic region is supported/deposited on the second catalytic region.

Another aspect of the present disclosure is directed to a method for treating a vehicular exhaust gas containing NOₓ, CO, and HC using the catalyst article described herein.

Another aspect of the present disclosure is directed to a system for treating exhaust gas comprising the catalyst article described herein.

### Definitions

The term “washcoat” is well known in the art and refers to an adherent coating that is applied to a substrate usually during production of a catalyst article.

The term “mixed oxide” as used herein generally refers to a mixture of oxides in a single phase, as is conventionally known in the art.

The term “composite oxide” as used herein generally refers to a composition of oxides having more than one phase, as is conventionally known in the art.

The expression “substantially free of” as used herein with reference to a material, typically in the context of the content of a region, a layer or a zone, means that the material in a minor amount, such as less than about 5 wt %, preferably less than about 2 wt %, more preferably less than about 1 wt %. The expression “substantially free of” embraces the expression “does not comprise.”

The expression “essentially free of” as used herein with reference to a material, typically in the context of the content of a region, a layer or a zone, means that the material in a trace amount, such as less than about 1 wt %, preferably less than 0.5 wt %, more preferably less than about 0.1 wt %. The expression “essentially free of” embraces the expression “does not comprise.”

The term “loading” as used herein refers to a measurement in units of g/ft³ on a metal weight basis.

The following examples merely illustrate the invention. Those skilled in the art will recognize many variations that are within the spirit of the invention and scope of the claims.

### Example 1

### Mixed Oxide OSC Materials

Mixed oxide OSC materials were prepared by co-precipitation of a solution containing metal salts including cerium, zirconium, and other rare-earth cations, and iron, manganese, or copper cation if present. The mixed oxide was calcined at 550° C. for 2 h. The characterization of these mixed oxides is shown in Table 1. REO refers to rare earth metal oxide(s).

TABLE 1

| | | | | | | | Surface |
|---|---|---|---|---|---|---|---|
| OSC | Composition (wt %) | | | | | | Area |
| Material | CeO₂ | ZrO₂ | REO | Fe₂O₃ | MnO₂ | CuO | (m²/g) |
| A | 50 | 42.5 | 7.5 | 0 | 0 | 0 | 60 |
| (Comparative) | | | | | | | |
| B | 50 | 42.2 | 7.5 | 0.3 | 0 | 0 | 60 |
| C | 50 | 41.9 | 7.5 | 0.6 | 0 | 0 | 60 |
| D | 50 | 41.5 | 7.5 | 1.0 | 0 | 0 | 60 |
| E | 50 | 40.5 | 7.5 | 2.0 | 0 | 0 | 60 |
| (Comparative) | | | | | | | |
| F | 50 | 42.2 | 7.5 | 0 | 0.3 | 0 | 60 |
| G | 50 | 42.2 | 7.5 | 0 | 0 | 0.3 | 60 |
| H | 45 | 45 | 10 | 0 | 0 | 0 | 60 |
| (Comparative) | | | | | | | |

### Example 2

### Reduction Efficiency of Mixed Oxide OSC Materials

Reduction efficiency of OSC materials A, B, F, G are shown in Table 2.

TABLE 2

| OSC Material | Reduction Efficiency |
|---|---|
| A (Comparative) | 27.5 |
| B (containing 0.3 wt % Fe₂O₃) | 41.6 |
| F (containing 0.3 wt % MnO₂) | 37.5 |
| G (containing 0.3 wt % CuO) | 40.6 |
| H (Comparative) | 32.0 |

### Example 3

### Aging Test of Mixed Oxide OSC Materials

Hydrothermal redox ageing tests at 1000° C. for 4 h were performed on OSC materials A, B, C, D, E, F and G under oxidizing atmosphere and reducing atmosphere gases which have the compositions shown in Table 3 below. The samples were exposed to alternating oxidizing and reducing atmospheres in three-minute intervals.

TABLE 3

| | H₂ (%) | CO (%) | O₂ (%) | H₂O (%) | N₂ |
|---|---|---|---|---|---|
| Oxidizing | 0 | 0 | 3 | 10 | Balance |
| Atmosphere Gas | | | | | |
| Reduction | 3 | 3 | 0 | 10 | Balance |
| Atmosphere Gas | | | | | |

Table 4 shows the BET surface area of mixed oxides A-E and H after aging at 1000° C. for 4 h. Sample E (2.0 wt % Fe₂O₃) showed dramatic decrease in surface area after aging as compared to samples B, C, and D.

TABLE 4

| | | Surface Area After |
|---|---|---|
| OSC Material | Fe₂O₃ wt % | Aging Test (m²/g) |
| A (Comparative) | 0 | 31 |
| B | 0.3 | 30 |
| C | 0.6 | 28 |
| D | 1.0 | 15 |
| E (Comparative) | 2.0 | 8 |
| H (Comparative) | 0 | 24 |

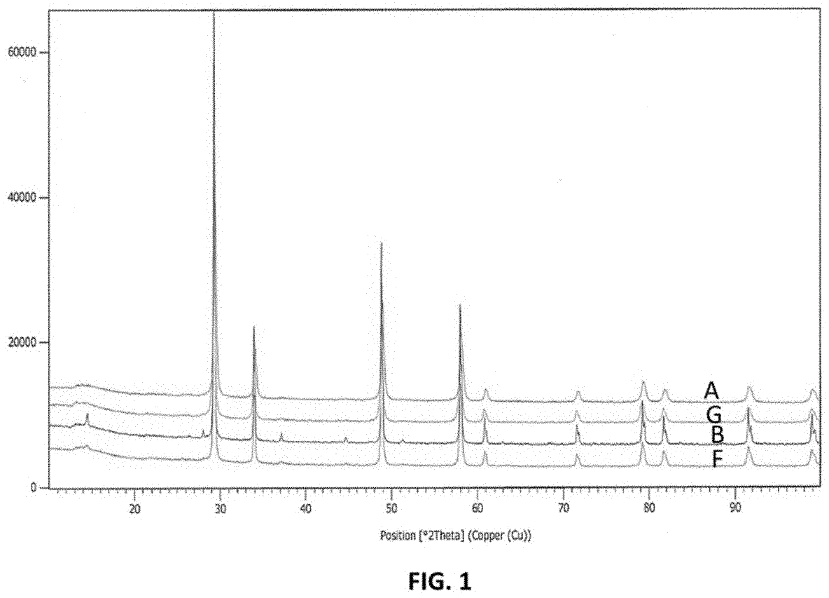

XRD revealed that pyrochlore formation is significant for OSC materials B and G, and tiny for OSC material F, while OSC material A does not contain pyrochlore phase after redox aging, as shown in FIG. 1.

### Example 4

### Catalyst Preparation and Model Gas OSC Test

Catalysts 1-4 in Table 5 below are three-way catalysts with a single-layered structure that were prepared with OSC materials A, B, F, and G. The catalyst layers include Pd supported on the OSC materials, a La-stabilized alumina, and a Ba promotor (4 wt %). The washcoat was coated on a flow through honeycomb substrate from NGK with dimensions 25.4×50.0 mm, 400 cells per square inch, and wall thickness 4 thousandths of an inch (0.10 mm) using techniques described in WO 1999/47260. The washcoat loading was about 2.0 g/in³ with a Pd loading of 100 g/ft³.

TABLE 5

| | | Oxygen Storage Capacity |
|---|---|---|
| Catalyst | OSC Material | at 400° C. (O₂ mmol/core) |
| 1 | A | 0.70 |
| (Comparative) | | |
| 2 | B | 1.05 |
| 3 | F | 0.74 |
| 4 | G | 0.79 |

Model gas OSC tests were conducted after pretreatment of 0.5% 0₂ gas (balance N₂), treating the catalyst at 500° C. Then, measurements of the concentrations of CO at 100, 150, 200, 250, 300, 350, 400, 450, and 500° C. were performed by switching between a lean gas composition (1% CO, balance N₂) and a rich gas composition (0.5% O_{2,} balance N₂) every 2 min at a spatial velocity of 60000/h. The measured oxygen storage capacities of catalysts 1-4 are shown in Table 5.

### Example 5

### Catalyst Preparation and Performance Test

### Catalyst 5 (Comparative)

Comparative Catalyst 5 is a three-way (Pd—Rh) catalyst with a double-layered structure. The bottom layer include Pd supported on OSC material A from Example 1, a first La-stabilized alumina, and a Ba promotor. The washcoat loading of the bottom layer was about 1.7 g/in³ with a Pd loading of 140 g/ft³. The top layer is a washcoat that include Rh supported on a second La-stabilized alumina. The washcoat lading of the top layer was about 0.6 g/in³ with a Rh loading of 24 g/ft³. The total washcoat loading of Comparative Catalyst 5 was about 2.3 g/in³.

### Catalyst 6

Catalyst 6 is a three-way (Pd—Rh) catalyst with a double-layered structure. The bottom layer is a washcoat including Pd supported on OSC material B from Example 1, a first La-stabilized alumina, and a Ba promotor. The washcoat loading of the bottom layer was about 1.7 g/in³ with a Pd loading of 140 g/ft³. The top layer is a washcoat that include Rh supported on a second La-stabilized alumina. The washcoat loading of the top layer was about 0.6 g/in³ with a Rh loading of 24 g/ft³. The total washcoat loading of Catalyst 6 was about 2.3 g/in³.

Comparative Catalyst 5 and Catalyst 6 were bench aged for 30 h with fuel cut aging cycles, with peak temperatures of 950° C. The OSC tests with gasoline engine were conducted with various flow rates. Catalyst performances by bag emission analysis are shown in Table 6.

TABLE 6

| | OSC Time (sec) at Each Flow Rate | | | |
|---|---|---|---|---|
| | 10 g/sec | 15 g/sec | 20 g/sec | 25 g/sec |
| Comparative Catalyst 5 | 8.53 | 7.16 | 6.40 | 5.80 |
| Catalyst 6 | 8.72 | 7.40 | 6.57 | 5.86 |

As shown in Table 6, Catalyst 6 showed improved OSC performance in comparison with Comparative Catalyst 5.

Vehicle emissions were conducted over a commercial vehicle with 1.5-litre engine. Emissions were measured at the position of the post-catalyst. Table 7 shows the catalyst performances by bag emission analysis.

TABLE 7

| | Weighted Tailpipe Emissions (g/mile) | | |
|---|---|---|---|
| | THC | CO/10 | NOₓ |
| Comparative Catalyst 5 | 0.027 | 0.166 | 0.103 |
| Catalyst 6 | 0.030 | 0.162 | 0.106 |

As shown in Table 7, Catalyst 6 showed similar emission of total hydrocarbon

(“THC”), CO, and NOₓ in comparison with Comparative Catalyst 5.

### Example 6

### Catalyst Preparation and Performance Test

### Catalyst 7 (Comparative)

Comparative Catalyst 7 is a three-way (Pd—Rh) catalyst set with two closed-couple bricks. The first brick is a double-layered structure. The bottom layer include Pd supported on OSC material H from Example 1, a first La-stabilized alumina, and a Ba promotor. The washcoat loading of the bottom layer was about 1.6 g/in³ with a Pd loading of 140 g/ft³. The top layer is a washcoat that include Rh supported on a second OSC and La-stabilized alumina. The washcoat lading of the top layer was about 1.0 g/in³ with a Rh loading of 24 g/ft³. The total washcoat loading of the first brick of Comparative Catalyst 7 was about 2.6 g/in³.

The second brick is a double-layered structure. The bottom layer include Pd supported on a third OSC and La-stabilized alumina, and a Ba promotor. The washcoat loading of the bottom layer was about 1.8 g/in³ with a Pd loading of 34 g/ft³. The top layer is a washcoat that include Rh supported on a fourth OSC and La-stabilized alumina. The washcoat lading of the top layer was about 2.0 g/in³ with a Rh loading of 6 g/ft³.

The total washcoat loading of the second brick of Comparative Catalyst 7 was about 3.8 g/in³.

### Catalyst 8

Catalyst 8 is a three-way (Pd—Rh) catalyst set with two closed-couple bricks. The first brick is a double-layered structure. The bottom layer include Pd supported on OSC material B from Example 1, a first La-stabilized alumina, and a Ba promotor. The washcoat loading of the bottom layer was about 1.6 g/in³ with a Pd loading of 140 g/ft³. The top layer is a washcoat that include Rh supported on a second OSC and La-stabilized alumina. The washcoat lading of the top layer was about 1.0 g/in³ with a Rh loading of 24 g/ft³. The total washcoat loading of the first brick of Catalyst 8 was about 2.6 g/in³.

The second brick is a double-layered structure. The bottom layer include Pd supported on a third OSC and La-stabilized alumina, and a Ba promotor. The washcoat loading of the bottom layer was about 1.8 g/in³ with a Pd loading of 34 g/ft³. The top layer is a washcoat that include Rh supported on a fourth OSC and La-stabilized alumina. The washcoat lading of the top layer was about 2.0 g/in³ with a Rh loading of 6 g/ft³.

The total washcoat loading of the second brick of Catalyst 8 was about 3.8 g/in³.

Vehicle emissions were conducted over a commercial vehicle with 1.5-litre engine. Emissions were measured at the position of the post-catalyst. Table 8 shows the catalyst performances by bag emission analysis.

TABLE 8

| | Weighted Tailpipe Emissions (g/mile) | | |
|---|---|---|---|
| | THC | CO/10 | NOₓ |
| Comparative Catalyst 7 | 0.0120 | 0.3296 | 0.0125 |
| Catalyst 8 | 0.0116 | 0.3003 | 0.0112 |

As shown in Table 8, Catalyst 8 showed reduced emission of total hydrocarbon (“THC”), CO, and NO), in comparison with Comparative Catalyst 7.

What is claimed:

1. An oxygen storage capacity material comprising a mixed oxide, the mixed oxide comprising ceria in an amount of about 10 wt % to about 80 wt %; zirconia in an amount of about 10 wt % to about 80 wt %; and a transition metal oxide in an amount of about 0.05 wt % to about 1.0 wt %, wherein the transition metal is selected from the group consisting of titanium, vanadium, chromium, manganese, iron, cobalt, copper, zinc, zirconium, niobium, and mixtures thereof.

2. The oxygen storage capacity material of claim 1, wherein the transition metal is selected from the group consisting of manganese, iron, copper, and mixtures thereof.

3. The oxygen storage capacity material of claim 2, wherein the transition metal is iron.

4. The oxygen storage capacity material of claim 1, wherein the transition metal oxide is in an amount of about 0.1 wt % to about 0.8 wt %.

5. The oxygen storage capacity material of claim 1, wherein the mixed oxide comprises a dopant.

6. The oxygen storage capacity material of claim 5, wherein the dopant is selected from the group consisting of lanthanum oxide, neodymium oxide, ytterbium oxide, praseodymium oxide, and mixtures thereof.

7. The oxygen storage capacity material of claim 1 comprising pyrochlore phase as determined by XRD.

8. A catalyst composition comprising a platinum group metal (PGM) component and the OSC material of claim 1.

9. The catalyst composition of claim 8, wherein the transition metal is selected from the group consisting of manganese, iron, copper, and mixtures thereof.

10. The catalyst composition of claim 9, wherein the transition metal is iron.

11. The catalyst composition of claim 8, wherein the transition metal oxide is in an amount of about 0.1 wt % to about 0.8 wt %.

12. The catalyst composition of claim 8, further comprising an inorganic oxide support.

13. A catalyst article for treating exhaust gas comprising:
a substrate; and
a first catalytic region on the substrate, wherein the first catalytic region comprises a first PGM component and an oxygen storage capacity material of claim 1.

14. The catalyst article of claim 13, wherein the transition metal is selected from the group consisting of manganese, iron, copper, and mixtures thereof.

15. The catalyst article of claim 14, wherein the transition metal is iron.

16. The catalyst article of claim 13, wherein the transition metal oxide is in an amount of about 0.1 wt % to about 0.8 wt %.

17. The catalyst article of claim 13, wherein the first catalytic region comprises a first inorganic oxide support.

18. The catalyst article of claim 13, further comprising a second catalytic region.

19. An emission treatment system for treating a flow of a combustion exhaust gas comprising the catalyst article of claim 13.

20. A method of treating an exhaust gas from an internal combustion engine comprising contacting the exhaust gas with the catalyst article of claim 13.
